(19) United States
(12) Patent Application Publication
(10) Pub. No.: US 2015/0220697 A1
(43) Pub. Date: Aug. 6, 2015

(54) SYSTEM AND METHOD FOR HEALTH ASSESSMENT

(71) Applicant: Access Business Group International LLC, Ada, MI (US)

(72) Inventors: Sheri A. Hunt, Manhattan Beach, CA (US); Micheline A. Vargas, Glendale, CA (US); Kerry A. Grann, Lansing, MI (US); Franco Silva, Grand Rapids, MI (US)

(21) Appl. No.: 14/608,893

(22) Filed: Jan. 29, 2015

Related U.S. Application Data
(60) Provisional application No. 61/934,034, filed on Jan. 31, 2014.

(51) Int. Cl. G06F 19/00

(52) U.S. Cl. CPC G06F 19/3431; G06F 19/3481

(57) ABSTRACT

A system and method of providing a health assessment. A health assessment may include a health related recommendation and identification of a primary barrier to adherence to the health related recommendation. The health assessment, health related recommendation, and bather can be provided to the user in a simple and easy to understand visual representation. The visual representation can be generated based on barrier priority logic that can determine which health assessment index poses the highest barrier to the user.

### BACKGROUND OF THE INVENTION

The present invention relates generally to providing a health assessment.

Some diet programs provide a questionnaire to would-be dieters at the outset of the program relating to diet and physical activity in order to assess the dieter's baseline situation. For example, Weight Watchers and Retrofit, two well-known diet programs, utilize questions to assess diet, physical activity and mindset (i.e., self-efficacy for belief in weight loss). Many known weight loss programs do not assess the appropriate areas of a user's lifestyle and do not use validated questionnaires in their assessments.

There are a variety of different diet and exercise plans, many of which experts agree will cause weight loss. One problem with these plans is that starting the plan and maintaining adherence to the plan can be difficult. There are a variety of possible barriers to starting or staying on a diet or exercise plan. A dieter may not know that these barriers exist. Alternatively, a dieter may believe that there are too many barriers and that the situation is insurmountable. Further, many programs do a poor job summarizing the information in a digestible way and explaining to users where they should focus their efforts.

### SUMMARY OF THE INVENTION

The present invention is generally directed to a system and method of providing a health assessment. A health assessment can be provided that includes a health related recommendation and can include identification of a primary barrier to successful adherence to the health related recommendation. The health assessment, health related recommendation, and barrier can be provided to the user in a simple and easy to understand visual representation.

One aspect of the present invention is directed to a system and method of providing a visual representation of a health assessment. A plurality of questions can be provided or communicated to a user for assessing the user's health. Answers to the questions can be received and used to determine a user's health assessment index score for different health assessment indexes based on the answers the user provides. The user's health assessment index scores can be used to classify the user within each of the different health assessment indexes. Further, the primary barrier, if any, can be identified based on the user's health assessment index classifications and application of a logical hierarchy of the different health assessment index classifications. The method can include generating a visual representation of the user's health assessment including the user's classification of each of the plurality of different health assessment indexes. The user's health assessment index classification that is identified as the primary barrier can be emphasized relative to the other classifications of the user in the visual representation.

Another aspect of the present invention is directed to a computer-implemented method for providing a health recommendation tailored to a user. The method includes communicating a plurality of questions to a user for assessing the user's diet, physical activity, mindset, sleep, stress, and meal habits, receiving answers to the plurality of questions, determining a user's diet index score, physical activity index score, mindset index score, sleep index score, stress index score, and diet habits index score by accumulating weighted point values for answers to the plurality of questions. The method may also include generating a health recommendation based on at least the user's diet index score.

Another aspect of the invention is directed to a self-contained health assessment tool for providing a health recommendation. The tool may include a plurality of questions for assessing a user's health. For example, the tool may include questions directed to assessing a user's diet, physical activity, mindset, sleep, stress, and meal habits. The tool may include instructions for scoring the user on a plurality of health related indexes based on the user's answers to the questions. For example, the answers to the questions can be used to determine a user's diet index score, physical activity index score, mindset index score, sleep index score, stress index score, and diet habits index score by accumulating weighted point values for answers to the plurality of questions. The tool may include multiple visual representations of health assessments and may map the user's combination of index scores to the appropriate visual representation. The visual representations in the tool may indicate a primary barrier and the mapping may include mapping the user's combination of index scores to the appropriate visual representation and the appropriate primary barrier based on a logical hierarchy of health assessment classifications.

The method may also include classifying the user's diet, physical activity, mindset, sleep, stress, and meal habits. Physical activity can be classified based on the physical activity index score where the user's physical activity is classified as at least one of high in general activity and high in structured activity, high in general activity and low in structured activity, low in general activity and high in structured activity, and low in general activity and low in structured activity. The user's mindset can be classified based on the mindset index score where the user's mindset is classified as at least one of certain, confident, optimistic, and uncertain. The user's sleep can be classified based on the sleep index score where the user's sleep is classified as at least one of deep and ample, light and ample, deep and brief, and light and brief. The user's stress can be classified based on the stress index score where the user's stress is classified as at least one of low, moderate, and high. The user's meal habits can be classified based on the meal habits index score where the user's meal habits are classified as at least one of good and need improvement. The method can also include determining a primary barrier to adherence of the health recommendation according to the following classification hierarchy: uncertain mindset, light and brief sleep, high stress, deep and brief sleep, light and ample sleep, moderate stress. A visual representation can be generated and provided to the user of the recommended health assessment that emphasizes or highlights the determined primary barrier to adherence of the health recommendation.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 illustrates a method of generating a visual representation of a health assessment.

FIG. 2 illustrates a method of generating a visual representation of a health assessment, health related recommendation, and barrier.

FIG. 3A-3C illustrate three embodiments of logic health assessment index classification models.

FIG. 4 illustrates exemplary classifications for several health assessment indexes in one embodiment of the present invention.

FIG. 5 illustrates one embodiment of a visual representation of a health assessment.

FIG. 6 illustrates another embodiment of a visual representation of a health assessment.

FIG. 7 illustrates yet another embodiment of a visual representation of a health assessment.

FIG. 8 illustrates one embodiment of a system for providing a health assessment.

### DESCRIPTION OF THE CURRENT EMBODIMENT

The present invention is generally directed to providing a visual representation of a health assessment that may include a health related recommendation and identification of a barrier to adherence to the health related recommendation. One aspect of the invention is directed to providing a visual representation of a health assessment. Another aspect of the invention is focused on identifying a health related recommendation and a barrier to following that health related recommendation.

The health assessment tool can accurately assess multiple scientifically supported key drivers in weight management. The tool can provide a score for each of the areas and highlight the primary barrier or barriers that affect weight loss. The health assessment tool can display results in a unique and appealing way. In one embodiment, a wheel graphic can help narrow focus to a barrier or barriers that the individual should focus on first. This can help the user reduce feelings of being overwhelmed, which can reduce decision anxiety. Reducing decision anxiety can improve successful undertaking of new health behaviors. By narrowing focus to a primary barrier or barriers, user program compliance can be improved.

The health assessment recommendations may be developed by PhD level researchers and practitioners. All recommendations can be supported by clinical research studies and the recommendations can also be shown effective in clinical practice.

Recommendations can gradually guide the user to take action in certain areas to increase or maximize results. This can include guidance in goal setting based on responses to assessment questions. Users can be guided in setting up a rewarding system, which can positively reinforce new positive/healthy behaviors shown to improve weight loss success. Obstacles, barriers, and triggers can be examined and planned for.

Research supported tools and techniques can be used in the health assessment program. These tools and techniques can be based on scientifically supported theories and models such as, motivational interviewing, the transtheoretical model, social cognitive theory, self-determination theory, health behavior change model, positive affect, laughter, gratitude, mindfulness, and self-compassion.

Positive reinforcement can be provided to participants for areas they are currently doing well in. This can support self-efficacy, a factor in weight loss success.

The health assessment tool can provide immediate feedback as a motivational tool. This feedback may include not only the individuals score in a plurality of health related areas, but may also detail one or more scientifically supported recommendations. Some known programs may provide a score, but lack detailed recommendations and fail to address several key factors influencing weight loss success such as, individualized diet type—for example, low carbohydrate vs. high carbohydrate, caloric intake, sleep quality/quantity, meal timing, stress management, and/or self-efficacy.

The health assessment can be retaken multiple times. This user can evaluate progress and receive updated individualized results and recommendations. This can improve self-efficacy, motivation, and support continued health behavior changes in the long term.

A health assessment can provide personalized information to a user about their health and can provide a foundation for entry into a tailored health program. The health assessment can identify specific barriers to weight loss or other health issues. For example, in one embodiment a health assessment can focus on 6 key areas known to impact weight loss—Diet, Physical Activity, Sleep, Stress, Mealtime Habits and Mindset. An individual can receive personalized results that can provide guidance for making health related decisions.

The health assessment can be based on answers to a variety of health related questions. In the current embodiment, the system and method for providing a health assessment includes asking questions about a user's diet, exercise, stress, sleep, meal timing, and mindset. Assessment of these areas can assist in the ability to make an appropriate health recommendation. A health recommendation can essentially be any recommendation to improve a user's health, for example a health recommendation can be a diet plan recommendation or exercise plan that aims to support a user's weight loss or other health related efforts. Each user can be scored on an independent index associated with each of these areas, which can be used to create a holistic scientifically-based health assessment index model.

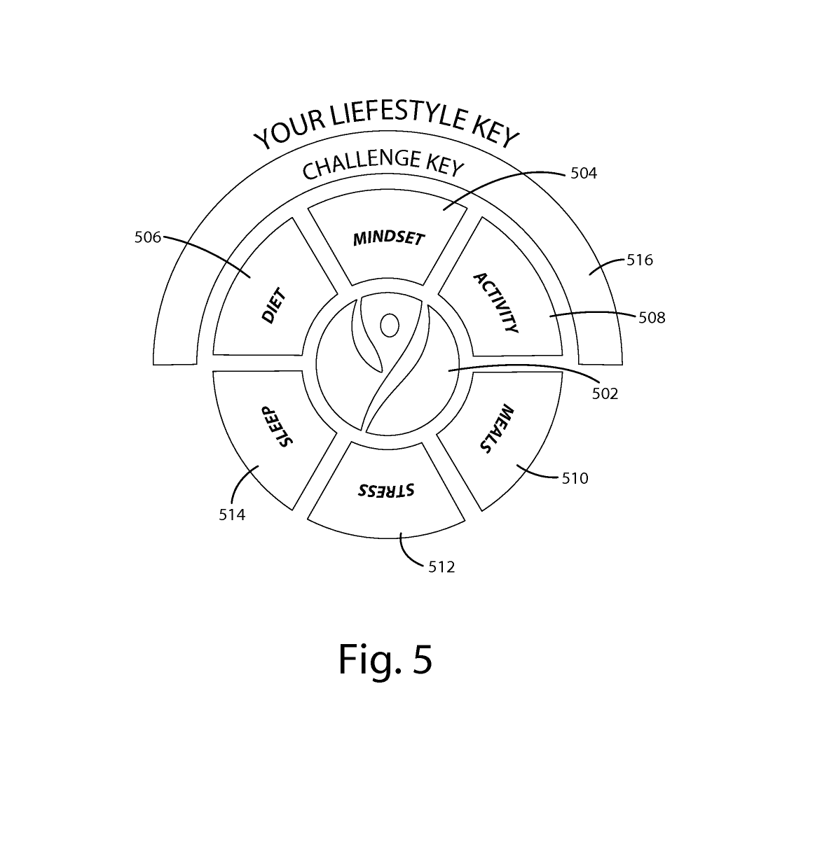

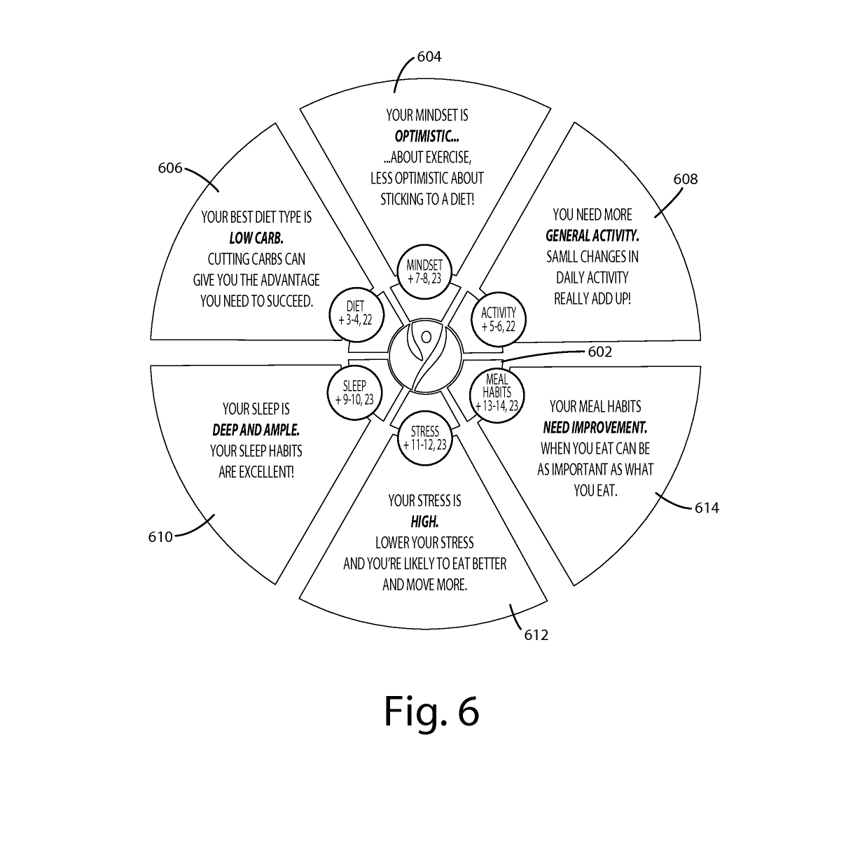

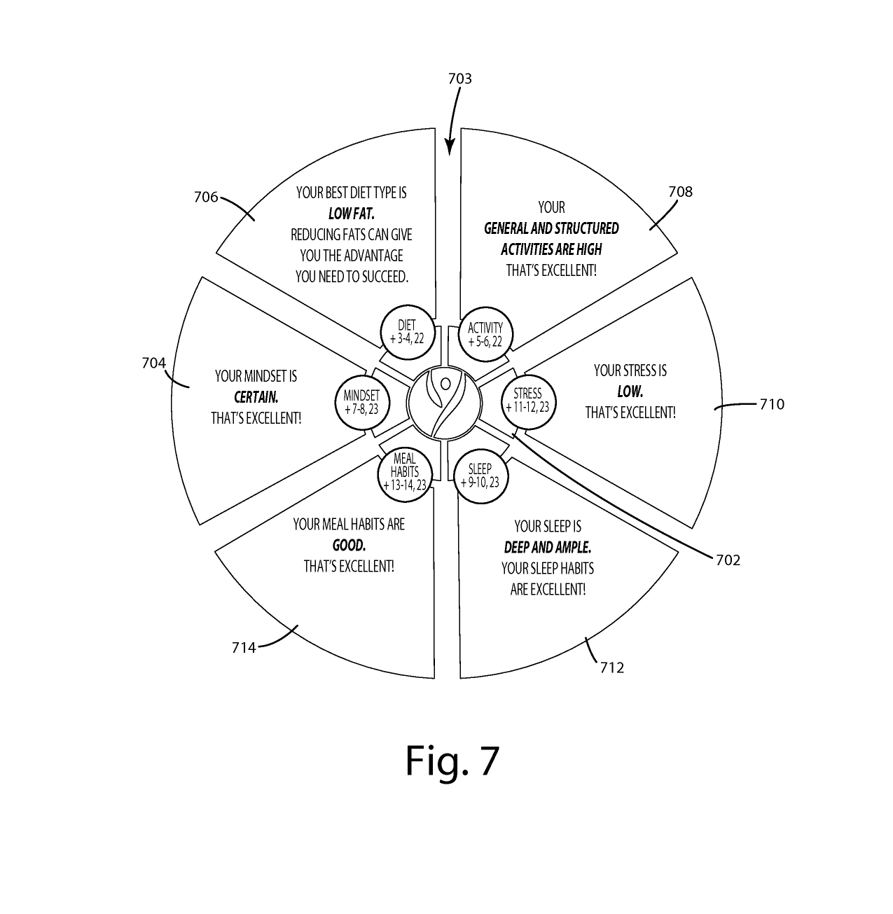

A visual representation can be generated and provided to a user in order to summarize the user's health assessment. In one embodiment, the results breakdown is a combination of results from six health assessment areas, sometimes referred to as health assessment indexes. FIGS. 5-7 illustrate several examples of health assessment visual representations. FIG. 5 shows a circular or wheel-shaped health assessment visual representation that indicates mindset is the primary barrier to success for the user. In the FIG. 5 embodiment, the barrier is indicated in two ways. First, the indicator for the mindset health assessment sector 504 is positioned in the top/middle of the visual representation. Second, the color of the health assessment or personal icon 502 matches the mindset health assessment sector 504 color. The personal icon is an “at a glance” representation of the user's health assessment result. The central color is themed to coincide with primary barrier. FIGS. 6 and 7 illustrate additional embodiments of circular or wheel shaped health assessment visual representations. These visualizations specify particular health assessment classifications based on the user's scores on the six health assessment indexes: diet, mindset, physical activity, meal habits, stress, and sleep. In the FIG. 6 health assessment visual representation, the user's barrier is mindset, indicated by color of the health assessment icon 602 matching the mindset health assessment sector 604 and the indicator for the mindset health assessment sector 604 being positioned in the top/middle of the visual representation. FIG. 7 illustrates a barrier-free health assessment. The barrier-free configuration can be identified because a gap 703 between health assessment sectors is oriented in the top/middle of the visual representation and the health assessment icon 702 is glowing and does not match the color of any of the health assessment sectors.

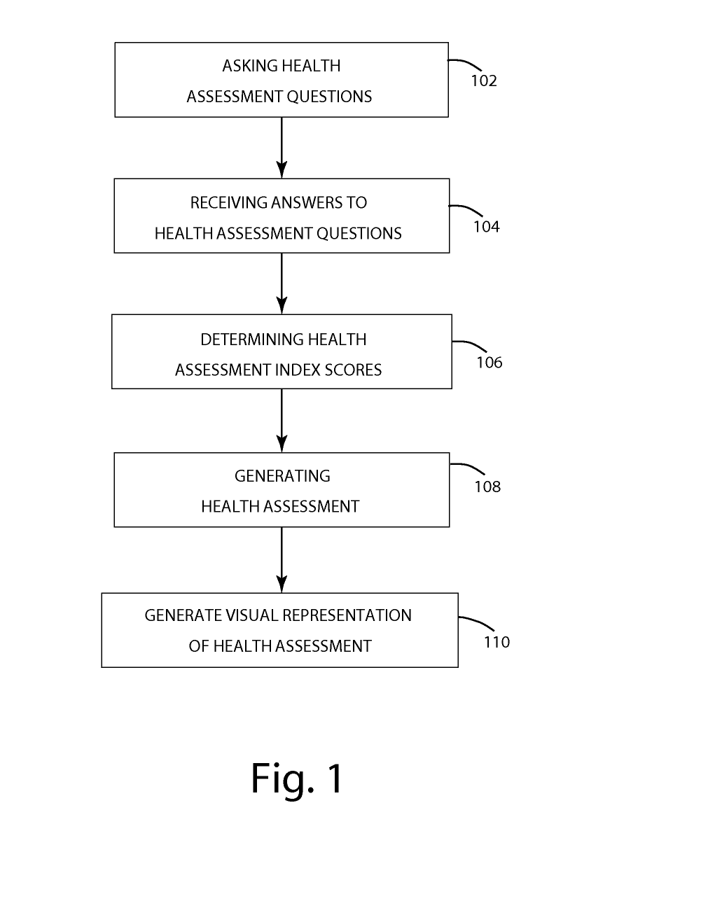

There are a variety of embodiments for providing a visual representation of a health assessment. FIG. 1 illustrates one embodiment of a method of providing a visual representation of a health assessment. The method can generally include asking a user a plurality of health assessment questions 102, receiving answers to the plurality of health assessment questions 104, scoring the user on a plurality of health assessment indexes based on the answers to the health assessment questions 106, generating a health assessment of the user by classifying the user into one of a plurality of classifications for each health assessment index 108, and generating a visual representation of the health assessment including an indicator for each health assessment index classification 110.

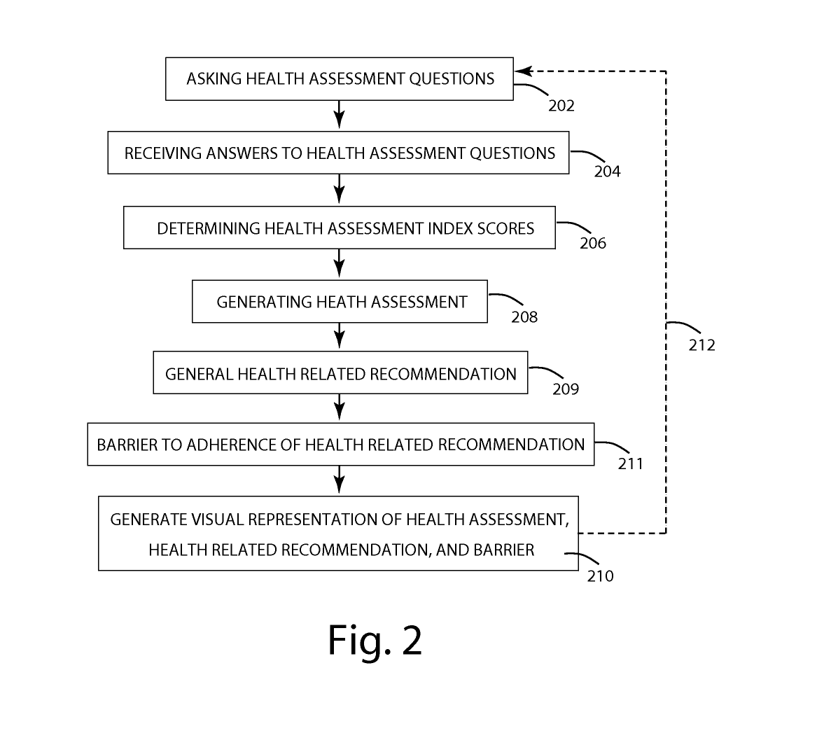

FIG. 2 illustrates an embodiment of a method of providing a visual representation of a health assessment, health related recommendation, and barrier to adherence of the health related recommendation. This method largely mimics the method from FIG. 1, with the addition of generating a health related recommendation based on one or more answers to the health assessment questions 202 and determining whether one of the health assessment index classifications is a barrier to adherence of the health related recommendation 204. In addition, the visual representation of the health assessment is configured to indicate the health related recommendation and the health assessment index classification that is the highest barrier to adherence to the health related recommendation (if one exists). If none of the health assessment index classifications are barriers to adherence to the health related recommendation, the visual representation of the health assessment is depicted in a barrier-free configuration. The method may also include iteration step 212 where the process is repeated to determine if the user's health assessment, health related recommendation, or barrier have changed. For example, in one embodiment, reassessment occurs at 12 week intervals.

A health assessment can include asking a variety of different questions to the user. The questions can be administered orally, written, communicated from a web server to a user's personal device (i.e., smart phone, laptop, or home computer) over the Internet, or provided to the user in essentially any other way. The questions may or may not identify the topic to which they relate. For example, the questions may be labeled and organized relating to a particular topic. Alternatively, the questions may be asked without providing the context about which index or indexes the question pertains. The questions may be answered by the user privately without supervision.

Tables 1-7 provide an exemplary questionnaire of one embodiment that includes health related questions, weighted point values, and logic for classifying a user's diet (carbohydrate index), physical activity (NEAT index), mindset (including both exercise mindset and nutrition mindset index), stress index, meal habits index, and sleep index. Additional, different or fewer questions may be utilized in alternative embodiments that pertain to additional, fewer, or different health assessment indexes.

The questions may be administered via scientifically validated methodology. The questions may include scientifically validated questions that enhance the health assessment by providing higher reliability and internal consistency. Validated questions have increased precision in measuring health assessment. Further, validated questions increase the user's ability to read instructions, questions, and response options carefully, completely and accurately. Validated questions ensure accuracy in assessing key health assessment factors such as sleep, stress, macronutrient factors (based on risk factors/glucose sensitivity, formal exercise/NEAT, mindset—nutrition & exercise self-efficacy, and meal timing).

The answers to the questions can be received orally, written, or via an electronic communication from the user. In the current embodiment, the answers to the questions are provided over the Internet to a server that includes memory and a processor for analyzing the answers in order to determine the health assessment results.

A health assessment system can be utilized in order to convert the user's answers to the health assessment questions into health assessment index scores. For example, in the current embodiment, each of the answers to the health assessment questions is associated with a weighted point value on a health assessment index. The user's score for a particular health assessment index can be determined by accumulating the weighted point values in for all of the questions relating to that health assessment index in order to assign a composite score for that index. That score can then be processed according to health assessment classification logic for that index in order to classify the user on that index.

In one embodiment, the health assessment indexes that the health assessment is based on include a diet index, a physical activity index, a mindset index, a stress index, a sleep index, and a meal habits index. In alternative embodiments, additional, different, or fewer health assessment indexes can be utilized in making a health assessment.

In one embodiment, the plurality of health assessment indexes scored to arrive at a user's health assessment may include a diet type index, physical activity index, a mindset index, a sleep index, a stress index, and a meal habit index. The health assessment indexes can be based on clinical research findings that support their role in weight management as well as outcomes research in support of strategies to improve them.

The diet index can be referred to as the diet type index or the carbohydrate index.

In one embodiment, the diet type index can be predictive for determining whether a user will respond better to a low carbohydrate diet or a low fat diet. A user's score on the diet index can indicate appropriate macronutrient meal composition and optimal calorie intake, which are components to weight loss. Research shows that certain users can be more sensitive or tolerant to carbohydrates than others. The health assessment carbohydrate index can utilize recent research to evaluate and recommend optimal nutrient intake to improve weight loss success. The diet type index can be predictive for determining diabetes in an undiagnosed population, and for energy intake and preferred macro nutrient opportunities. In one embodiment, the Simplified Indian Diabetes Risk Score is used to determine which users are most likely to benefit from a low carbohydrate diet. In one embodiment, a user is recommended a low fat diet if a determination is made that the user likely will not benefit from a low carbohydrate diet. Exemplary questions relating to a carbohydrate index and a scoring system for the carbohydrate index are provided in Table 1.

TABLE 1
Diet or Carbohydrate Index (CI)

| | | |
|---|---|---|
| 1. | What is your age? (choose one) | |
| | ∘ 35 years of age or younger | Points = 0 |
| | ∘ 36-49 years of age | Points = 20 |
| | ∘ 50 years of age or older | Points = 30 |
| 2. | Do you have a family history of diabetes? | |
| | ∘ Yes | Points = 0 |
| | ∘ No | Points = 0 |
| 3. | If you have a family history of diabetes, does your | |
| | father and/or your mother have diabetes? | |
| | ∘ Father | Points = 10 |
| | ∘ Mother | Points = 10 |
| | ∘ Both parents | Points = 20 |
| 4. | What is your waist circumference? | |
| | ∘ Female: Waist less than 80 cm (31 in.) | Points = 0 |
| | ∘ Female: Waist less than or equal to 80-89 cm | Points = 10 |
| | (31-35 in.) | |
| | ∘ Female: Waist 90 cm or greater (35 in.) | Points = 20 |
| | ∘ Male: less than 90 (35 in.) [male] | Points = 0 |
| | ∘ Male: greater than or equal to 90-99 cm (35-38 in.) | Points = 10 |
| | ∘ Male: 100 cm or greater (38 in.) | Points = 20 |
| 5. | Which of the following best describes you? | |
| | (choose one) | |
| | ∘ I exercise regularly AND have a physically | Points = 0 |
| | demanding job/occupation | |
| | ∘ I exercise regularly OR I have a physically | Points = 20 |
| | demanding job/occupation | |
| | ∘ I do not exercise and I have a sedentary | Points = 30 |
| | job/occupation | |

Score 10-100: CI ≧ 60 = low carbohydrate diet. CI < 60 =
low fat diet.

The physical activity index can classify a user's physical activity. In one embodiment, the International Physical Activity Questionnaire is used to determine which users have low and high levels of structured physical activity. Additional questions are provided to assess a person's amount of general movement or non-structured physical activity. By assessing a user's structured physical activity and non-structured physical activity a physical activity recommendation or exercise program can be tailored and recommended. Exemplary questions relating to an Activity Index and a scoring system for the activity index are is provided in Table 2.

TABLE 2
Activity Index

| | | |
|---|---|---|
| 1. | I engage in physical movement (i.e., walking, pacing, and standing) for at | |
| | least 5 minutes. (choose one) | |
| | ∘ At least every 90 minutes | Points = 1 |
| | ∘ At least every 60 minutes | Points = 2 |
| | ∘ At least every 30 minutes | Points = 3 |
| | ∘ None of the above | Points = 0 |

Scoring General Movement Interval: Low <3: High = ≧3

| | | |
|---|---|---|
| 2. | How many minutes of non-exercise activity (i.e., standing, pacing, easy | |
| | yard work, fidgeting) do you accumulate during a typical day? | |
| | ∘ <40 minutes | Points = 0 |
| | ∘ 40-79 minutes | Points = 1 |
| | ∘ 80-119 minutes | Points = 2 |
| | ∘ > or = 120 minutes | Points = 3 |

Scoring General Movement Duration: Low = <2; High = ≧2
General Movement Overall Scoring: Sum the 2 scores for a total of 0-6 points.

| | |
|---|---|
| | • Low General Movement = <5 points |
| | • High General Movement = >5 points |
| 3. | During the past seven days, on how many days did you do vigorous physical activities, such as |
| | heavy lifting, aerobics, and fast bicycling? If you were unable to engage in physical activity |
| | (i.e., due to illness) please indicate how many days you typically engage in vigorous physical |
| | activities each week. |
| | Days per week |
| | No vigorous physical activity |
| 4. | How much time did you usually spend doing vigorous physical activities on one of those days? |
| | Hours per day |
| | Minutes per day |
| 5. | During the past seven days, on how many days did you do moderate physical activities; such as |
| | carrying light loads, bicycling at a regular pace, doubles tennis, or table tennis? If you were |
| | unable to engage in physical activity (i.e., due to illness) please indicate how many days you |
| | typically engage in moderate physical activities each week. |
| | Days per week |
| | No moderate physical activity (skip the next question) |
| 6. | How much time did you usually spend doing moderate physical activities on one of those days? |
| | Hours per day |
| | Minutes per day |
| 7. | During the past seven days, on how many days did you walk at least 10 minutes at a time? |
| | Days per week |
| | No walking |
| 8. | On one of those days, how much time did you usually spend walking? |
| | Hours per day |
| | Minutes per day |

Physical Activity (IPAQ) Scoring:
Low or no reported PA = <600 MET minutes per week, High PA = ≧600 MET minutes per week.
Calculation: Sum minutes of PA and # of days of walking, moderate activity, and vigorous activity.

• •Walking MET-min/wk (questions 7-8) = 3.3 X # walking minutes X # walking days
• •Moderate MET-min/wk (questions 5-6) = 4.0 X # moderate minutes PA X # moderate

activity days

• •Vigorous MET-min/wk (questions 3-4) = 8.0 X # vigorous minutes of PA X # vigorous

activity days
*If the participant enters duration in hours this can be converted to minutes to calculate the PA Index score.
NOTE:
While METS for low (walking), moderate, and high are calculated, the resulting score can indicate either Low PA or High PA. This is because the Moderate MET and High MET groups can be collapsed into one HIGH PA group for the BodyKey Assessment. This information can be used to offer additional personalization within the high PA group.

The mindset index can be separated into two separate indexes: a mindset food index and a mindset exercise index. The Mindset Index can assess both dietary self-efficacy and exercise self-efficacy. The questions can be seeded randomly throughout the questionnaire per a validated methodology. In one embodiment questions for the diet mindset index are hidden in the Meal Habit Index and the Stress Index questions. The mindset food or diet index can predict a user's self-efficacy for food compliance. The mindset exercise index can predict a user's self-efficacy for activity compliance. In one embodiment, the validated Weight Efficacy Life-Style questionnaire can be used to assess diet self-efficacy. This index assesses the user's confidence to refrain from eating in a variety of different situations. The validated Exercise Self Efficacy Scale can be used to identify exercise self-efficacy. Exemplary questions relating to an Exercise Mindset Index and a Diet Mindset Index along with scoring systems for each are provided in Table 3 and Table 4.

TABLE 3
Exercise Mindset Index

I am confident that . . .

| | | |
|---|---|---|
| 1. | . . . I could always overcome barriers and challenges with | |
| | regard to exercise if I try hard enough. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 2. | . . . I could find the means and ways to exercise and be | |
| | physically active. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 3. | . . . that it is easy for me to accomplish my activity and | |
| | exercise goals. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 4. | . . . I can participate in physical activity without the | |
| | help of an exercise therapist. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 5. | . . . I could exercise even if I had no access to a gym or | |
| | training facility. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 6. | . . . when something prevents me from participating in | |
| | physical activity, I can usually find several alternative | |
| | ways to be active. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 7. | . . . I can participate in physical activity even when I feel | |
| | depressed (saddened). (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 8. | . . . I can participate in physical activity even if I do not | |
| | have the support of my family or friends. (Choose one) | |
| | ∘ Not at all true | Points = 1 |
| | ∘ Hardly true | Points = 2 |
| | ∘ Moderately true | Points = 3 |
| | ∘ Exactly true | Points = 4 |
| 9. | . . . I can participate in physical activity even if I am | |
| | tired. (Choose one) | |
| | ∘ Not at all true | Points = 1 |
| | ∘ Hardly true | Points = 2 |
| | ∘ Moderately true | Points = 3 |
| | ∘ Exactly true | Points = 4 |

Score 9-40: ≦26 Low Exercise Mindset; >26 High Exercise Mindset

TABLE 4
Diet Mindset Index (self-efficacy)

Question 1-19: I can resist (i.e., decline or avoid) . . .

| 1. | . . . eating when there are many different kinds of foods | |
|---|---|---|
| | available. (Choose one) | |
| | 0 1 2 3 4 5 6 7 8 9 | Points 0-9 |
| | Not very confident-Very confident | |
| 2. | . . . eating even when high calorie foods are available. | |
| | (Choose one) | |
| | 0 1 2 3 4 5 6 7 8 9 | Points 0-9 |
| | Not very confident-Very confident | |
| 3. | . . . eating even when I have to say “no” to others. | |
| | (Choose one) | |
| | 0 1 2 3 4 5 6 7 8 9 | Points 0-9 |
| Not very confident-Very confident | | |
| 4. | . . . even when I have a headache. (Choose one) | |
| | 0 1 2 3 4 5 6 7 8 9 | Points 0-9 |
| | Not very confident-Very confident | |
| 5. | . . . eating when I am watching TV. (Choose one) | |
| | 0 1 2 3 4 5 6 7 8 9 | Points 0-9 |
| | Not very confident-Very confident | |
| 6. | . . . eating when I am reading. (Choose one) | |
| | 0 1 2 3 4 5 6 7 8 9 | Points 0-9 |
| | Not very confident-Very confident | |
| 7. | . . . eating just before going to bed. (Choose one) | |
| | 0 1 2 3 4 5 6 7 8 9 | Points 0-9 |
| | Not very confident-Very confident | |
| 8. | . . . eating when I am depressed (saddened or down) | |
| | (Choose one) | |
| | 0 1 2 3 4 5 6 7 8 9 | Points 0-9 |
| | Not very confident-Very confident | |
| 9. | . . . eating when I feel happy. (Choose one) | |
| | 0 1 2 3 4 5 6 7 8 9 | Points 0-9 |
| | Not very confident-Very confident | |
| 10. | . . . eating when I am at a party. (Choose one) | |
| | 0 1 2 3 4 5 6 7 8 9 | Points 0-9 |
| | Not very confident-Very confident | |
| 11. | . . .eating when I think others will be upset if I don't | |
| | eat. (Choose one) | |
| | 0 1 2 3 4 5 6 7 8 9 | Points 0-9 |
| | Not very confident-Very confident | |
| 12. | . . . eating when I have experienced failure. (Choose one) | |
| | 0 1 2 3 4 5 6 7 8 9 | Points 0-9 |
| | Not very confident-Very confident | |
| 13. | . . . eating when I feel it's impolite to refuse a | |
| | second helping. (Choose one) | |
| | 0 1 2 3 4 5 6 7 8 9 | Points 0-9 |
| | Not very confident-Very confident | |
| 14. | . . . eating when I am angry (mad or irritable). | |
| | (Choose one) | |
| | 0 1 2 3 4 5 6 7 8 9 | Points 0-9 |
| | Not very confident-Very confident | |
| 15. | . . . eating when others are pressuring me to eat. | |
| | (Choose one) | |
| | 0 1 2 3 4 5 6 7 8 9 | Points 0-9 |
| | Not very confident-Very confident | |
| 16. | . . . eating when I feel physically rundown. (Choose one) | |
| | 0 1 2 3 4 5 6 7 8 9 | Points 0-9 |
| | Not very confident-Very confident | |
| 17. | . . . eating when I am in pain. (Choose one) | |
| | 0 1 2 3 4 5 6 7 8 9 | Points 0-9 |
| | Not very confident-Very confident | |
| 18. | . . . eating when I feel uncomfortable. (Choose one) | |
| | 0 1 2 3 4 5 6 7 8 9 | Points 0-9 |
| | Not very confident-Very confident | |
| 19. | . . . eating when I am anxious (nervous) (Choose one) | |
| | 0 1 2 3 4 5 6 7 8 9 | Points 0-9 |
| | Not very confident-Very confident | |
| 20. | I can control my eating on the weekends. (Choose one) | |
| | 0 1 2 3 4 5 6 7 8 9 | Points 0-9 |
| | Not very confident-Very confident | |

Score 0-180 points: ≦130 Nutrition Mindset Low; >130 Nutrition Mindset
High

The Perceived Stress Scale is a validated questionnaire for measuring a user's perception of stress and can be utilized as a stress index. Exemplary questions relating to a stress index and a scoring system for the stress index are provided in Table 5.

TABLE 5
Stress Index

Question 1-10: In the last month . . .

| | | |
|---|---|---|
| 1. | . . . how often were you upset because something | |
| | happened unexpectedly? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 2. | . . . how often did you feel unable to control the | |
| | important things in your life? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 3. | . . . how often did you feel nervous and “stressed”? | |
| | (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 4. | . . . how often did you feel confident in your ability to | |
| | handle your personal problems? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 5. | . . . how often did you feel that things were going your | |
| | way? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 6. | . . . how often did you discover you were unable to cope | |
| | with everything you had to do? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 7. | . . . how often were you able to control irritations in your | |
| | life? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 8. | . . . how often did you feel you had things under control? | |
| | (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 9. | . . . how often did you feel angry because of things were | |
| | outside of your control? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |
| 10. | . . . how often did you feel you had too many problems | |
| | to overcome? (Choose one) | |
| | ∘ Never | Points = 0 |
| | ∘ Almost never | Points = 1 |
| | ∘ Sometimes | Points = 2 |
| | ∘ Fairly often | Points = 3 |
| | ∘ Very often | Points = 4 |

Score 0-40: <11 = Less than Average; 11-14 = Average; ≧15 Higher
than Average

The sleep index can determine a user's duration and quality of sleep. Exemplary questions relating to a sleep index and a scoring system for the sleep index are provided in Table 6.

TABLE 6
Sleep Index

| 1. | . . . how often have you slept seven or more hours per | |
|---|---|---|
| | night? (Choose one) | |
| | ∘ Not at all | Points = 3 |
| | ∘ Once a week | Points = 2 |
| | ∘ Twice a week | Points = 1 |
| | ∘ Three or more times a week | Points = 0 |
| | Scoring Duration: <1 = Good Sleep Duration; ≧1 Low Sleep | |
| | Duration | |
| 2. | . . . how often have you been restless while sleeping? | |
| | (Choose one) | |
| | ∘ Not at all | Points = 0 |
| | ∘ Once a week | Points = 1 |
| | ∘ Twice a week | Points = 2 |
| | ∘ Three or more times a week | Points = 3 |
| 3. | . . . how often have you been sleepy when driving or | |
| | reading? (Choose one) | |
| | ∘ Not at all | Points = 0 |
| | ∘ Once a week | Points = 1 |
| | ∘ Twice a week | Points = 2 |
| | ∘ Three or more times a week | Points = 3 |
| 4. | . . . how would you rate your overall quality of sleep? | |
| | (Choose one) | |
| | ∘ Not at all | Points = 0 |
| | ∘ Once a week | Points = 1 |
| | ∘ Twice a week | Points = 2 |
| | ∘ Three or more times a week | Points = 3 |

Scoring (2 scores):

1. Sleep Duration Score (question 1): 0-3: <1 = Good Sleep Dura-
tion; ≧1 = Poor Sleep Duration.
2. Overall Sleep Habits Score (sum question 1-4): Score 0-12: <6 =
Good Sleep Habits; ≧6 = Poor Sleep Habits.

The meal habit index can predict a user's weight loss and time to lose weight. Exemplary questions relating to a meal habit index and a scoring system for the meal habit index are provided in Table 7.

TABLE 7
Meal Habit Index

| | | |
|---|---|---|
| 1. | When do you typically eat your largest meal? | |
| | (Choose one) | |
| | ∘ Before 3pm | Points = 10 |
| | ∘ After 3pm | Points = 0 |
| 2. | Do you typically eat breakfast? (Choose one) | |
| | ∘ Yes | Points = 10 |
| | ∘ No | Points = 0 |

MHI Score = 0-20, <20 Poor choices; ≧20 Good choices. Shared
focus is time of eating <3pm good habit, >3pm poor habit and eating
of breakfast. Both behaviors provide an advantage to weight loss.

A user can be classified into one of a plurality of classifications for each index. For example, depending on how the user responds to the health related questions, the user's physical activity can be classified as low general movement and low structured activity, high general movement and low structured activity, low general movement and high structured activity, or high general movement and high structured activity. The user's classification in an index can be determined by accumulating a point value for that index based on responses to the health related questions. Each index includes a plurality of classifications that correspond to a numerical value or numerical range of values. For example, in one embodiment, ten of the questions are dedicated to determining the user's stress level. In this embodiment, each question can be answered in one of five ways: Never, Almost Never, Sometimes, Fairly Often, and Very Often. Each response is associated with a point value 0-4. The user's stress index score is determined by accumulating the total amount of points for all 10 questions. The user's stress can be classified by comparing the user's stress index score to pre-defined values or ranges. For example, in one embodiment, a stress index score greater than 15 indicates high or higher than average stress, a stress index score of 11-14 indicates average stress, and a stress index score of less than 11 indicates low or less than average stress.

In one embodiment, questions may be skipped by tracking a user's score and skipping questions once they are not relevant to the user's classification. That is, if a user answers some of the health related questions in a way such that the user's score for that index falls within a specific classification range regardless of the answers of the remaining questions, then the remaining, unanswered, questions relating to that index can be skipped because the user responses will not influence the user's classification of that index. For example, if a stress score greater than 15 indicates high or higher than average stress and is the classification based on the highest score, then once the user has responded to enough questions to accumulate a 15 or higher stress score, then no further stress questions need to be asked and can instead be skipped. This feature may be implemented with respect to some, all, or none of the indexes.

For embodiments implementing this skipping feature, the questionnaire may be configured in a way to ask questions that have higher weighted point values before questions that have relatively lower weighted point values in order to increase the chance that questions can be skipped and the questionnaire can be shortened. In one embodiment, the processor can be configured to provide questions to the user and score the user's responses. The processor dynamically tracks the user's index score and uses it in part to determine what question to ask. Questions relating to a certain index can be skipped automatically if the user's score is sufficiently defined within a classification and the responses to the questions cannot or are unlikely to change the user's classification for that index.

The health assessment index scores can be utilized to generate a user's health assessment. A user's health assessment may include providing numerical values of the user's scores on the health assessment index. In alternative embodiments, the user's health assessment may include classifications based on the user's scores on the health assessment index. The health assessment may include a health related recommendation and identification of a barrier to adherence of the health related recommendation.

In one embodiment the health assessment or lifestyle areas can be broken down into the following classifications. A user's mindset can be uncertain, optimistic, confident, or certain. A user's physical activity can be low general activity/low structured exercise, low general activity/high structured exercise, high general activity/low structured exercise, or high general activity/high general activity. A user's sleep can be light and brief, deep and brief, light and ample, or deep and ample. A user's stress can be high, moderate, or low. A user's diet type can be low carbohydrate or low fat. A user's meal habits can be good or need improvement. These classifications can be determined based on classification logic such as a comparison of the user's health assessment index score to one or more thresholds or threshold ranges. For example, Tables 1-7 provide exemplary classification logic for classifying a user's mindset, diet, stress, sleep, physical activity, and meal habits.

In addition to providing a health assessment, the health assessment system and method can provide a health related recommendation. In one embodiment, a health related recommendation includes a diet-type recommendation based on a user's score on the diet-type index. For example, either a low carbohydrate diet or a low fat diet may be recommended to a user depending on answers to the health assessment questions. In another embodiment, the health related recommendation provides a recommended exercise program in addition to or instead of a diet-type recommendation. Recommendations can guide a user to take health related action to increase health related results.

The user may have one or more barriers to success or adhering to a health related recommendation. Identifying multiple or all of a user's barriers to success can be overwhelming and unhelpful. In some situations, identifying too many barriers can be counterproductive. It can be helpful to prioritize any barriers and present only a user's primary or highest barrier. Further, identifying that the user does not have a barrier to adherence of the health related recommendation can also be helpful.

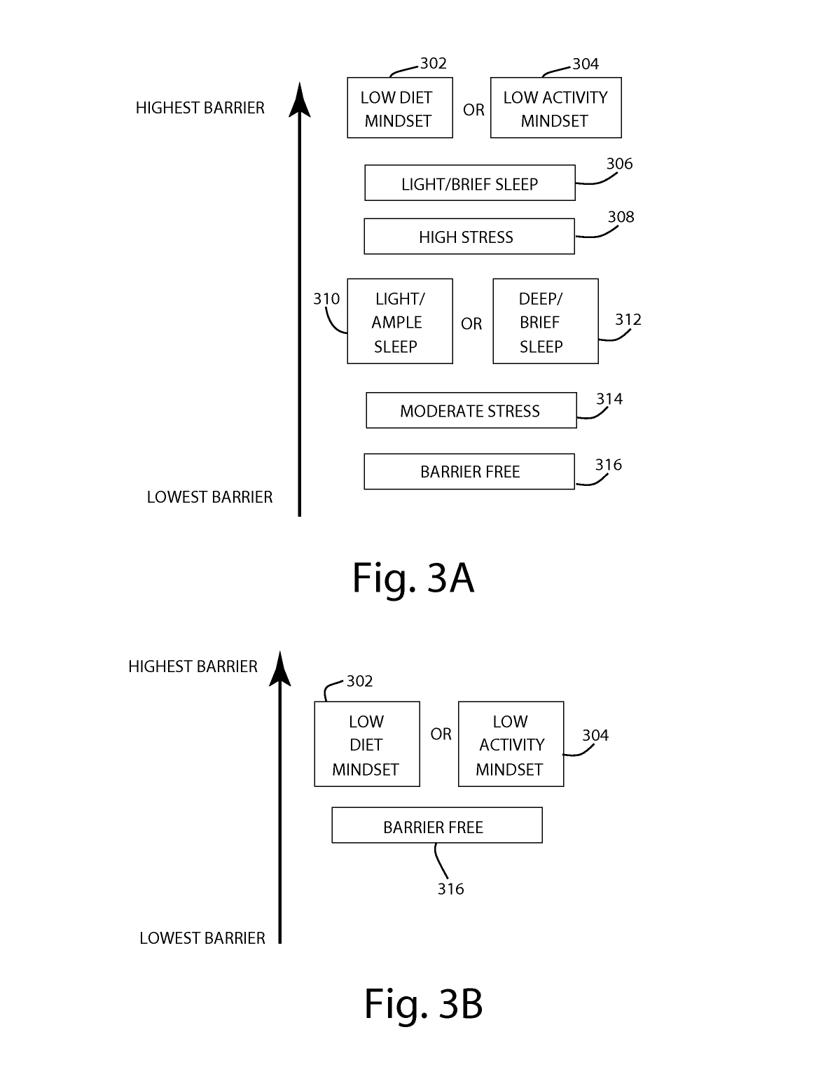

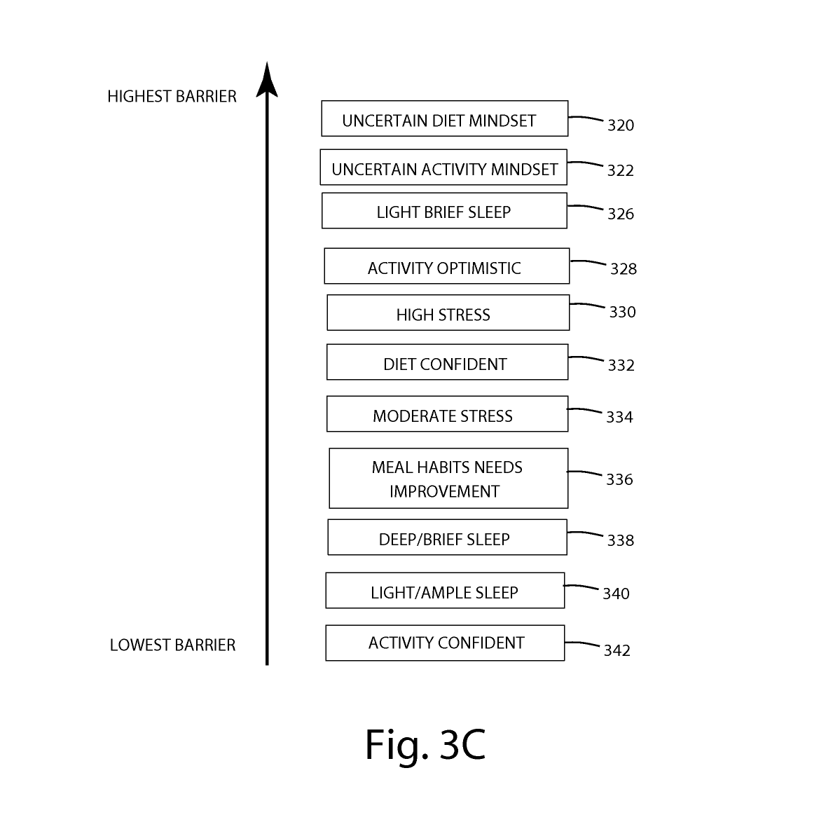

There are a number of different embodiments that each can execute different barrier priority logic in order to identify the appropriate barrier or barriers. FIGS. 3A-3C illustrate three separate embodiments of barrier priority logic. In the FIG. 3A embodiment, if the user is classified as either having a low diet mindset 302 or low activity mindset 304, then that is the user's primary barrier. If the user does not have a low diet mindset 302 or low activity mindset, but is classified as having light and brief sleep 306, then light and brief sleep is identified as the user's primary barrier. The hierarchy continues where the classifications higher on the hierarchy trump the classifications below. In this way, the user's primary barrier will be identified as high stress 308, light and ample sleep or deep 310 and brief sleep 312, moderate stress 314, or barrier free 316, depending on the user's classifications. Barrier free is a condition that happens when there is no known highest barrier.

FIG. 3B illustrates an alternative embodiment where a user's barrier is identified as either low mindset (low diet mindset 302 or low activity mindset 304) or as barrier free 316. FIG. 3C illustrates yet another alternative embodiment of barrier priority logic. In FIG. 3C the hierarchy provides from highest barrier to lowest barrier the following classifications: uncertain diet mindset 320, uncertain activity mindset 322, light brief sleep 326, activity optimistic 328, high stress 330, diet confident 332, moderate stress 334, meal habits need improvement 336, deep and brief sleep 338, light and ample sleep 340, and activity confident 342.

Identification of a barrier according to barrier priority logic provides the user with a manageable, clear, and understandable barrier to work on, without overwhelming the user with all of the reasons that a health related recommendation might not be successful. FIGS. 3A-3C implements a trumping hierarchy where a subset of health assessment index classifications are assigned relative positions within a health assessment index hierarchy and classifications higher in the hierarchy trump lower classifications in the hierarchy as being primary barriers. Although the lower classifications may also be barriers, in the current embodiment they are not indicated as primary barriers. In alternative embodiments, a different logical structure may be utilized in order to identify the primary barrier.

In one embodiment, identification of a primary barrier that affects weight loss allows the system and method to personalize a weight loss recommendation specific to the individual. Identification of a primary barrier can help reduce decision anxiety. Decision anxiety can reduce adherence to a health behavior change program. Further, change in one health behavior can increase chances for change in other health behaviors. Accordingly, by narrowing focus to a primary barrier program compliance of the user can be increased.

The system and method can generate one or more visual representations of a health assessment. The visual representation of the health assessment can include a variety of health assessment graphics. In one embodiment, a lifestyle key or health assessment wheel is provided that summarizes the user's health assessment. FIGS. 6-7 illustrate one embodiment of a health assessment wheel that provides a user's classification in six health assessment areas: mindset, diet type, physical activity, sleep, stress, and meal habits. Although the health assessment wheels illustrated in FIGS. 5-7 provide pleasing aesthetics, it is understood that alternative embodiments may integrate different shapes, sizes, and colors into the visual representation of a health assessment.

The visual representation of the health assessment is configured such that it can be quickly digested and understood by a user without having to sift through a lengthy report. In the lifestyle key embodiment, the classifications provide simple, tailored advice. By keying the primary barrier off of the relative position and orientation of the health assessment sectors, the user can be directed to focus on their primary barrier without being overwhelmed. Further, upon iteration, the user can understand changes to their situation by simple rotation of the lifestyle key to indicate a new barrier or changes in classifications. For example, the sleep sector and the mindset sector in FIG. 6 might swap positions if the user addresses their mindset barrier within before being reassessed.

The visual representation of a health assessment can be governed by a set of visualization logic that can vary from application to application. The visualization logic in the embodiments depicted in FIGS. 6-7 is governed by five rules. First, the center icon 602, 702 can be colored to match the highest barrier. Second, if there is a primary barrier, the top/center sector can be positioned to be the primary barrier. Third, the left of the primary barrier can be the user's diet result. Fourth, the right of the primary barrier can be the user's physical activity result. Fifth, if no highest barrier is identified, then the user can be deemed barrier free and the visual representation can be depicted in a barrier-free configuration. In alternative embodiments, the primary barrier can be highlighted or emphasized in a different or supplemental way. For example, the primary barrier may be emphasized using a dynamic graphical change such as by causing the primary barrier classification to blink or glow. The blinking or glowing can be done in addition to or instead of other methods of highlighting or emphasizing the primary barrier. Secondary, tertiary, or other barriers may also be highlighted or emphasized, for example those barriers may blink, glow, or be associated with a different type of dynamic graphical change.

FIG. 6 illustrates a visual representation of a health assessment where the user has an optimistic mindset about exercise but less optimistic about sticking to a diet, a low carb diet type, need for more general activity, deep and ample sleep, high stress level, and meal habits need improving. These six classifications are provided in a wheel or circular visual graphic where each of the six classifications: diet type 606, mindset 604, physical activity 608, sleep 610, stress 612, meal habits 614 are positioned as pie-piece shaped sectors of the wheel. The position of the sectors can convey additional information to the user. In the depicted embodiment, the mindset sector is positioned in the top/middle of the visual representation in order to indicate that this is the user's primary barrier. If a different health assessment area were the user's primary barrier, then it would be placed in the top/middle position instead. The graphic also includes a barrier indicator 602 that has a matching color as the health assessment area that is the user's primary barrier.

FIG. 7 illustrates a visual representation of a barrier-free health assessment. In the depicted visual representation the user has a recommended low fat diet type 706 and has been classified as having high general and structured activities 708, low stress 710, deep and ample sleep 712, good meal habits 714, and a certain mindset 704. The gap 703 between the diet type health assessment sector 706 and the physical activity health assessment sector 708 is oriented in the top/middle position of the visual representation in order to provide a visual indication that the health assessment is barrier free. In addition the health assessment icon or personal icon 702 is glowing and does not match the color of any of the health assessment sectors.

In alternative embodiments, different visual representations of health assessments can be provided. For example, in FIG. 5 a visual representation of a health assessment is provided without classifications. In the depicted embodiment, the top three areas of the visual representation are identified as challenge keys. The challenge keys can provide focus to the top three areas an individual can work on.

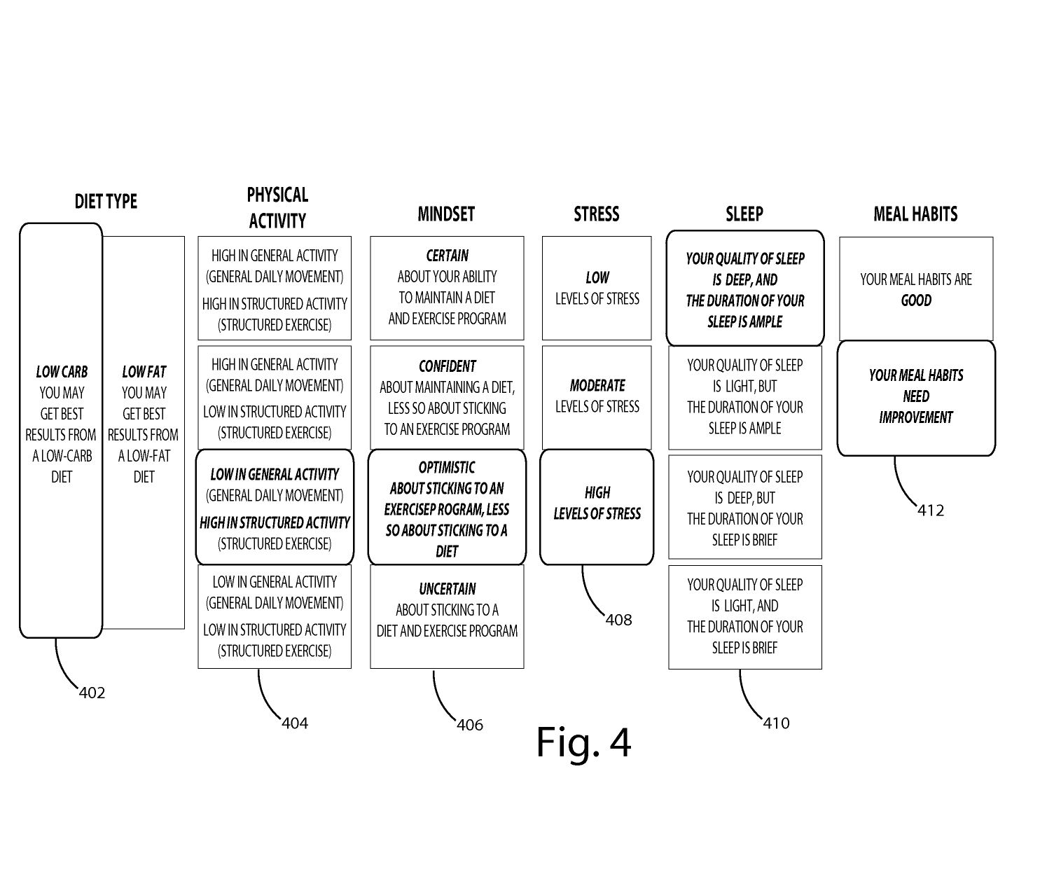

In yet another embodiment, illustrated in FIG. 4, a visual representation can be provided that highlights the health assessment classification relative to the other classifications for each health assessment index. For example, the diet type index 402 includes two classifications: low carb or low fat. The physical activity index 404 can be classified as high in general activity and high in structured activity, high in general activity and low in structured activity, low in general activity and high in structured activity, and low in general activity and low in structured activity. The mindset index 406 can be classified as certain, confident about diet, optimistic about exercise, or uncertain. The sleep index 410 can be classified as at least one of deep and ample, light and ample, deep and brief, and light and brief. The stress index 408 can be classified as low stress, moderate stress, or high stress. The meal habits index 412 can be classified as good or needs improvement.

The system and method may include providing a health assessment report that can include a health assessment visual representation such as the lifestyle key discussed above as well as various tips, quotes, facts, advice, benefits, motivators and other information about the health assessment. The report may be crafted dynamically based on the answers to the user's questions according to a set of report logic. For example, the report logic can affect the personal icon in the lifestyle key, the lifekey designation, challenge key content, recommendation content/personalized tips, summary chart, and individual bather identification.

One embodiment of the present invention is directed to a health assessment system 800. The health assessment system 800 can include a server 802 and a client 804. The client and server can receive and transmit information to each other using their respective communication systems 807, 817. For example, in one embodiment, the server is a web server that can be accessed over the Internet using a client web browser.

The client 804 may include input/output 818, such as a monitor and keyboard/mouse. The monitor may display health questions to the user and display a visual representation of a health assessment to a user generated by the server 802. The input device can be used to provide responses to the health related questions. The client can be essentially any electronic device including that has I/O 818, a communication system 817, and memory 820, such as a smart phone, laptop, or home computer. In one embodiment, the client does not include a communication system, but is connected to a printer for printing the response to the health related questions.

The server 802 may include input output 808, such as a monitor and keyboard/mouse. Alternatively, the server 802 may not include any direct input or output devices. The server 802 may also include a processor 806, a communication system 807, and memory 810. Reference to memory throughout the description of the health assessment system including the client and server may refer to a data warehouse, data base or essentially any other data storage structure for use in a computer system.

The health assessment questionnaire in server memory 810 can be provided to the client and the responses to the health assessment questionnaire can be stored in server memory 810. The server processor 806 can determine the user index scores based on the weighted values for scoring stored in memory 810. The user index scores can be used to determine the user index classifications based on the index classification logic stored in memory. For example, the index classification logic may include thresholds or ranges of thresholds for each index that serve to categorize the user index scores into one of a plurality of classifications. The user index classifications can be stored in server memory and used for generating a visualization and/or determining a primary barrier.

The barrier priority logic stored in server memory 810 may be utilized to determine the user's primary barrier, challenge keys, secondary or tertiary barriers, or essentially any other barrier related outcomes. The results may be stored in server memory 810 as the user barrier information.

A health assessment visualization may be generated by the server utilizing the visualization logic in memory 810. For example, the visualization logic may be utilized to produce a health assessment graphic such as the lifestyle key wheel depicted in FIG. 6. The visualization logic can be used to determine the user index classifications to be printed in the sectors of the lifestyle key wheel, the orientation of the lifestyle key wheel, the theme or color of the personal icon, and essentially any other details relating to the visualization of the health assessment graphic dependent on responses to the health related questions that are stored in memory.

One aspect of the invention is directed to a self-contained health assessment tool. The tool may be electrical, mechanical, or electro-mechanical tool. The tool may include a plurality of questions for assessing a user's health. For example, the tool may include questions directed to assessing a user's diet, physical activity, mindset, sleep, stress, and meal habits. The tool may include instructions for scoring the user on a plurality of health related indexes based on the user's answers to the questions. For example, the answers to the questions can be used to determine a user's diet index score, physical activity index score, mindset index score, sleep index score, stress index score, and diet habits index score by accumulating weighted point values for answers to the plurality of questions. The tool may include multiple visual representations of health assessments and may map the user's combination of index scores to the appropriate visual representation. The visual representations in the tool may indicate a primary barrier and the mapping may include mapping the user's combination of index scores to the appropriate visual representation and the appropriate primary barrier based on a logical hierarchy of health assessment classifications.

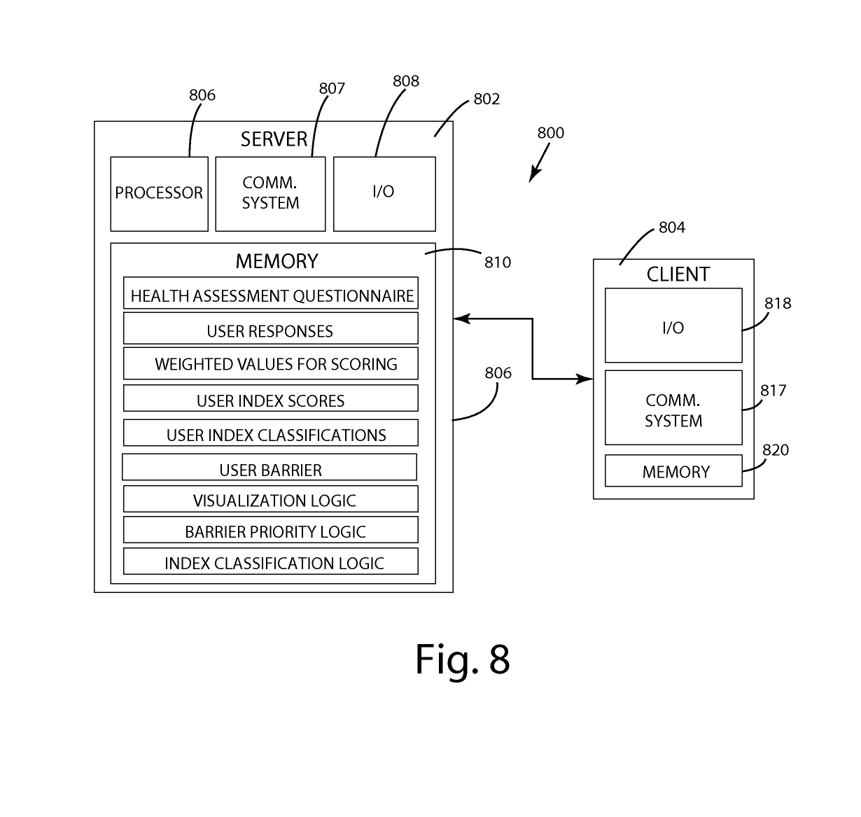

In one embodiment the tool may be an electrical apparatus with a controller and a dynamic graphical display or speakers for presenting questions to a user based on instructions from a controller and capable. The apparatus may include an input device, such as a keyboard or touch screen for providing responses to the questions. For example, instead of communicating questions from a server to a remote client computer as depicted in FIG. 8, a self-contained tool may include the components and intelligence in a self-contained apparatus to present questions to a user, accept input from a user, and present a visual graphical representation of a health assessment that may include emphasizing or highlighting the user's primary barrier.

In another embodiment the tool may be a mechanical or electro-mechanical apparatus with a display for displaying the health assessment questions. The answers to the questions can be input into the tool by mechanical or electrical inputs such as one or more mechanical levers, buttons, wheels or other mechanical or electro-mechanical selection input devices. The combination of input by the user can be utilized to automatically select an appropriate health assessment graphic visualization, which may or may not include a health related recommendation and a primary barrier to adherence of that health related recommendation. The graphic visualization may be constructed dynamically for example using an LCD screen, or selected from among a plurality of static pre-defined graphic visualizations. For example, pre-defined health assessment graphic visualizations may be included in the tool and selection of the appropriate visualization may be accomplished by reconfiguring the mechanical or electro-mechanical apparatus to highlight, emphasize, or otherwise display the appropriate health assessment graphic visualization. The health assessment graphic visualization itself may highlight or emphasize a primary barrier, as discussed elsewhere in connection with the other embodiments. For example, the primary barrier may be positioned in the top/center position of a health assessment classification wheel that displays the user's health assessment classifications in six areas (diet, physical activity, mindset, sleep, stress, and meal habits).

In one embodiment, the tool includes a rolodex-like device that can display different health assessment visualizations. For example, the tool may include a rotating cylinder constructed with a center bar that holds several removable cards. Each card may include a different health assessment graphic visualization and the combination of input by the user can provide instructions for the user to manually rotate or otherwise configure the rolodex-like device to display the appropriate health assessment graphic visualization. In one embodiment, the mechanical or electro-mechanical selection can interact with the rolodex or other display to automatically rotate or otherwise configure the rolodex-like device to display the appropriate health assessment graphic visualization.

The tool may be a book. The book may include health assessment questions for assessing a user's health and pre-defined health assessment graphic visualizations. The book can be configured in a variety of different ways to map a combination of answers to the health assessment questions to one or more of the pre-defined health assessment graphic visualizations.

In one embodiment, the book includes questions relating to multiple different health assessment indexes. Each question is provided with a weighted point value for at least one of the health assessment indexes. The user can determine their score for each health assessment index by accumulating their weighted point values for the questions relating to that health assessment index. The score of the health assessment index or combination of scores from different health assessment indexes can be used to direct the user to an appropriate health assessment graphic visualization in the book. For example, the book may include a series of “choose your own adventure” style instructions that instruct the user to turn to a certain page of the book depending on a health assessment index score or a combination of health assessment index scores. For example, if the user's health assessment index score for stress classifies them as high stress, the instruction in the book may instruct them to turn to page 50 where additional questions may be asked of the user related to a different health assessment index. As another example, if the user's health assessment index score for stress classifies them as high stress and their sleep index score classifies them as deep/ample, the instruction in the book may instruct them to turn to page 100 where additional questions may be asked of the user related to a different health assessment index. Ultimately, the book can instruct the user to turn to a certain page that displays a health assessment graphic visualization based on the answers to the health assessment questions provided by the user.

In one book embodiment, the book is configured such that once the user has answered the health assessment questions and obtained several health assessment index scores, such as a diet type index score, mindset index score, stress index score, meal habits index score, sleep index score, and physical activity index score, the user is directed to a health assessment graphic visualization based on the combination of health assessment index scores. For example, the book and the weighted point values may be arranged such that accumulation of the health assessment index scores results in a page number where the appropriate health assessment graphic visualization for that combination of health assessment index scores resides. The book may include instructions for utilizing each health assessment index score to arrive at a health assessment classification and the user may be directed to a certain health assessment graphic visualization, which may highlight or emphasize a primary barrier, in the book based on the combination of health assessment index classifications.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method of providing a visual representation of a health assessment, the method comprising:
providing a plurality of questions for assessing a user's health;
receiving answers to the plurality of questions for assessing the user's health;
determining a user's health assessment index score for each of a plurality of different health assessment indexes based on the answers to the plurality of questions;
classifying the user within each of the plurality of different health assessment indexes based on each of the respective health assessment index scores;
identifying which, if any, health assessment index is the user's primary barrier based on the user's health assessment index classifications and a logical hierarchy of the different health assessment index classifications;
generating a visual representation of the user's health assessment including the user's classification of each of the plurality of different health assessment indexes, wherein the user's health assessment index classification identified as the user's primary barrier is emphasized in the visualization relative to the other classifications of the user in the visual representation.

2. The method of claim 1 wherein determining the user's health assessment index score for each of the plurality of different health assessment indexes includes accumulating weighted points for each of the plurality of different health assessment indexes based on answers to at least a subset of the plurality of questions.

3. The method of claim 1 wherein the visual representation of the user's health assessment is depicted as a circle and the user's health assessment index classifications are presented as sectors within the circle.

4. The method of claim 3 wherein at least one of the user's health assessment index classifications are identified as the user's primary barrier and is emphasized in the visualization relative to the other classifications of the user in the visual representation by orienting the circle such that the user's health assessment index classification sector that is the primary barrier is positioned in a pre-determined position in the circle.

5. The method of claim 4 wherein the pre-determined position is the top-middle area of the circle.

6. The method of claim 3 wherein none of the user's health assessment index classifications are identified as the user's primary barrier and the barrier free health assessment is emphasized in the visualization by orienting the circle such that a gap between the user's health assessment index classification sectors is positioned in a pre-determined position in the circle.

7. The method of claim 6 wherein the pre-determined position is the top-middle area of the circle.

8. A computer-implemented method for providing a health recommendation tailored to a user, the method comprising:
communicating a plurality of questions to a user for assessing the user's diet, physical activity, mindset, sleep, stress, and diet habits;
receiving answers to the plurality of questions;
determining a user's diet index score, physical activity index score, mindset index score, sleep index score, stress index score, and diet habits index score by accumulating weighted point values for answers to the plurality of questions;
generating a health recommendation based on at least the user's diet index score for either a low carbohydrate or low fat eating plan;
classifying the user's physical activity based on the physical activity index score, wherein the user's physical activity is classified as at least one of high in general activity and high in structured activity, high in general activity and low in structured activity, low in general activity and high in structured activity, and low in general activity and low in structured activity;
classifying the user's mindset based on the mindset index score, wherein the user's mindset is classified as at least one of certain, confident, optimistic, and uncertain;
classifying the user's sleep based on the sleep index score, wherein the user's sleep is classified as at least one of deep and ample, light and ample, deep and brief, and light and brief;
classifying the user's stress based on the stress index score, wherein the user's stress is classified as at least one of low, moderate, and high;
classifying the user's meal habits based on the meal habits index score, wherein the user's meal habits are classified as at least one of good and need improvement;
determining a primary barrier to adherence of the health recommendation according to the following classification hierarchy: uncertain mindset, light and brief sleep, high stress, deep and brief sleep, light and ample sleep, moderate stress;
providing a graphical report of the recommended health assessment to the user that highlights the determined primary barrier to adherence of the health recommendation.

9. The computer-implemented method of claim 8 including determining a secondary barrier to adherence of the health recommendation and reporting the determined secondary barrier to adherence of the health recommendation to the user.

10. The computer-implemented method of claim 8 wherein the plurality of questions are validated questions.

11. The computer-implemented method of claim 8 that includes reevaluating the health recommendation and primary bather.

12. The computer-implemented method of claim 8 including providing a visual representation of the user's health assessment as a circle wherein the classification of the user's physical activity is provided in a first sector of the circle, the classification of the user's mindset is provided in a second sector of the circle, the classification of the user's stress is provided in a third sector of the circle, the classification of the user's sleep is provided in a fourth sector of the circle, the classification of the user's meal habits is provided in a fifth sector of the circle, and the user's health recommendation is provided in a sixth sector of the circle.

13. The computer-implemented method of claim 12 wherein the primary barrier is emphasized in the visualization by orienting the circle such that the classification sector that is the primary barrier is positioned in a pre-determined position in the circle.

14. The method of claim 13 wherein the pre-determined position of the sector is the top-middle area of the circle.

15. The method of claim 12 wherein no primary barrier is identified and a barrier free health assessment is emphasized in the visualization by orienting the circle such that a gap between the classification sectors is positioned in a pre-determined position in the circle.

16. The method of claim 15 wherein the pre-determined position is the top-middle area of the circle.

17. A computer-implemented method for recommending a weight loss program catered to a particular user and reporting a barrier to adherence of the weight loss program, the method comprising:
communicating a plurality of questions to a user for assessing the user's mindset and determining a personalized weight loss program recommendation;
receiving answers to the plurality of questions;
determining a user's mindset index score by accumulating weighted point values for answers to at least a subset of the plurality of questions;
generating a weight loss program recommendation for the user based on the answers to the plurality of questions;
determining whether the user's mindset is a barrier to adherence of the weight loss program based on comparison of the user's mindset index score to a threshold value;
in response to determining the user's mindset is a barrier to adherence of the weight loss program, reporting the weight loss program recommendation and the mindset barrier to adherence of the weight loss program to the user.

18. A computer-implemented method for recommending a weight loss program catered to a particular user and reporting a barrier to adherence, the method comprising:
communicating a plurality of questions to a user for assessing the user's diet, physical activity, mindset, sleep, stress, and diet habits;
receiving answers to the plurality of questions;
determining the user's diet index score, physical activity index score, mindset index score, sleep index score, stress index score, and meal habits index score by accumulating weighted point values for answers to the plurality of questions;
generating a weight loss program recommendation for the user based on at least a subset of the answers to the plurality of questions;
determining whether and which of at least one of the user's mindset, user's sleep, user's stress, and user's meal habits is a highest barrier to adherence of the weight loss program based on a logical priority hierarchy among the user's mindset index score, sleep index score, stress index score, and diet habits index score;
in response to determining that none of the user's mindset, user's sleep, user's stress, and user's diet habits are a primary barrier to adherence of the weight loss program, reporting the recommended weight loss program to the user in a bather-free configuration;
in response to determining that at least one of the user's mindset, user's sleep, user's stress, and user's diet habits is a primary barrier to adherence of the weight loss program, reporting the recommended weight loss program to the user in a barrier configuration.
